(19) United States
(12) Patent Application Publication
(10) Pub. No.: US 2018/0164485 A1
(43) Pub. Date: Jun. 14, 2018

(54) BACKLIGHT MODULE, NARROW FRAME LIQUID CRYSTAL DISPLAY DEVICE AND FORMATION PROCESS OF SEALANT

(71) Applicant: Wuhan China Star Optoelectronics Technology Co., Ltd., Wuhan City (CN)

(72) Inventor: Pengbo Xu, Wuhan City (CN)

(21) Appl. No.: 15/109,130

(22) PCT Filed: May 13, 2016
(86) PCT No.: PCT/CN2016/082128

§ 371 Date: Jun. 30, 2016

(30) Foreign Application Priority Data
Apr. 25, 2016 (CN) 201610260361.9

(51) Int. Cl. F21V 8/00

(52) U.S. Cl. CPC G02B 6/0023; G02B 6/0055; G02B 6/0053; G02B 6/0051

(57) ABSTRACT

The present invention provides a backlight module, a narrow frame liquid crystal display device and a formation process of sealant. In the backlight module, the sealant inner wall of the sealant has a surface with a graded gray scale, and thus, it can pertinently increase the gray scale of the sealant inner wall to absorb the light generating an edge bright line to eliminate the edge bright line, and then, the distance of the sealant and an edge of the active area of the liquid crystal display can be decreased to achieve the narrow frame design, and meanwhile to reduce the brightness lose of the backlight module. The narrow frame liquid crystal display device utilizes the aforesaid backlight module, and the distance of the sealant and the edge of the active area is smaller to achieve the narrow frame design, and the brightness lose of the backlight module is small.

### FIELD OF THE INVENTION

The present invention relates to a display skill field, and more particularly to a backlight module, a narrow frame liquid crystal display device and a formation process of sealant.

### BACKGROUND OF THE INVENTION

The Liquid Crystal Display (LCD) possesses advantages of thin body, power saving and no radiation to be widely used in many application scope, such as LCD TV, mobile phone, personal digital assistant (PDA), digital camera, notebook, laptop, and dominates the flat panel display field. Most of the liquid crystal displays on the present market are back light type liquid crystal display devices, which comprise a liquid crystal display panel and a back light module. Generally, the structure of the liquid crystal panel mainly comprises a Color Filter (CF), a Thin Film Transistor Array Substrate (TFT Array Substrate) and a Liquid Crystal Layer positioned inbetween. The working principle is that the light of backlight module is reflected to generate images by applying driving voltages to the two glass substrate for controlling the rotations of the liquid crystal molecules. Because the liquid crystal display panel itself does not emit light and needs the back light module to provide light source for normally showing images. Therefore, the backlight module is the key component of the liquid crystal display device.

The narrow frame liquid crystal display has advantages of simplicity, beauty and same size of visible area, and became the main development trend of the high quality display. As shown in FIG. 1, the liquid crystal display device according to prior art mainly comprises a backlight module 100, a liquid crystal panel 300 installed above the backlight module 100, wherein the backlight module 100 specifically comprises a LED lamp, sealant 110, square seal 120, a light guide plate 130, a brightness enhancement film and a diffusion film. As working, the LED lamp emits light, and the light is scattered by the light guide plate 130, and after the focus of the respective film layers, the surface of the entire backlight module 100 uniformly emits light; the sealant 110 is located at periphery of the light guide plate 130, and the backlight module 100 utilizes the structure with the cooperation of the sealant 110 and the square seal 120 to fix the liquid crystal panel 300 above.

At present, the achievement of the narrow frame design is mainly to decrease the width of the sealant 110 to diminish the side frame width. However, as shown in FIG. 1, the sealant 110 and the edge of the active area (AA) 310 of the liquid crystal panel 300 always needs to reserve a certain distance d, which is at least 0.75 mm in general for preventing the large view angle light leakage of display edge, and the square seal 120 is required for shielding a portion of upward light, i.e. to prevent the appearance of a bright line as watching the image edge from the large view angle. The image quality is influence and thus, it restricts the degree of narrowing the side frame in certain level.

Apparently, the gray scale of the inner surfaces of the sealant 110 opposite to the light guide plate 130 has influence to the light absorption. The darker the gray scale is, the absorption to the light is stronger. For solving the aforesaid issues, increasing the gray scale of the inner surface of the sealant 110 can achieve the decrease of the distance of the sealant 110 and the active area 310 of the liquid crystal panel 300. From the other side, the stronger the absorption of the sealant 110 to the light, the brightness lose of the backlight module 100 is larger; besides, the light intensities on the different areas of the inner surface of the sealant 110 are different, and if only single color becomes deeper for the inner surface of the sealant 110, the light is absorbed but it also may easily leads to the uneven local brightness of the display image. The traditional mold art can hardly realize the graded gray scale of the sealant.

### SUMMARY OF THE INVENTION

An objective of the present invention is to provide a backlight module, in which the sealant inner wall of the sealant has a surface with a graded gray scale, and thus, it can pertinently increase the gray scale of the sealant inner wall to absorb the light generating an edge bright line to eliminate the edge bright line of the liquid crystal display device, and then, to achieve the narrow frame design of the liquid crystal display device, and meanwhile to reduce the brightness lose of the backlight module.

Another objective of the present invention is to provide a narrow frame liquid crystal display device, in which the distance of the sealant and the edge of the active area is smaller to achieve the narrow frame design, and the brightness lose of the backlight module is small.

Another objective of the present invention is to provide a formation process of sealant. With the 3D printing technology to make the gray scale of the sealant inner wall graded, the narrow frame design of the liquid crystal display device can be achieved, and the large amount of mold cost and mold time can be saved.

For realizing the aforesaid objectives, the present invention first provides a backlight module, comprising: a light guide plate, sealant located at an periphery of the light guide plate, and square seal, being adhered on the sealant and covering a gap between the light guide plate and the sealant, and extending to cover periphery edges of the light guide plate;

the sealant comprises a sealant inner wall contacting lateral sides of the light guide plate and surrounding the periphery edges of the light guide plate, and the sealant inner wall has a graded gray scale.

Intensities of lights of respective areas on the sealant inner wall which are incident from the light guide plate are not consistent.

The gray scale of the area where the intensity of light on the sealant inner wall which is incident from the light guide plate is stronger, is higher.

The sealant comprises a sealant outer wall opposite to the sealant inner wall, and a distance H between the sealant outer wall and sealant inner wall is below 0.5 mm.

The backlight module further comprises an optical film located on the light guide plate; the optical film comprises lower diffusion film, a lower prismatic lens and an upper prismatic lens which are sequentially stacked up on the light guide plate.

An area of the optical film is equal to an area of the light guide plate, and the square seal cover periphery edges of the optical film.

The backlight module further comprises a reflective sheet located below the light guide plate.

The present invention further provides a narrow frame liquid crystal display device, comprising a liquid crystal panel and the aforesaid backlight module, and the backlight module is employed to provide backlight for the liquid crystal panel;

the liquid crystal panel comprises an active area and a border area at an outer periphery of the active area.

A distance D between a sealant inner wall and an edge of the active area is 0.6-0.75 mm.

The present invention further provides a formation process of sealant, utilizing 3D printing technology to manufacture the sealant with black material and white material passing through different feed exports according to different ratios to make a gray scale of a wall of the sealant graded.

The benefits of the present invention are: in the backlight module provided by the present invention, the sealant inner wall of the sealant has a surface with a graded gray scale, and thus, it can pertinently increase the gray scale of the sealant inner wall to absorb the light generating an edge bright line to eliminate the edge bright line of the liquid crystal display device, and then, the distance of the sealant and an edge of the active area of the liquid crystal display can be decreased to achieve the narrow frame design of the liquid crystal display device, and meanwhile to reduce the brightness lose of the backlight module. The narrow frame liquid crystal display device of the present invention utilizes the aforesaid backlight module, and the distance of the sealant and the edge of the active area is smaller to achieve the narrow frame design, and the brightness lose of the backlight module is small. The formation process of sealant according to the present invention utilizes the 3D printing technology to make the gray scale of the sealant inner wall graded. In comparison with the mold prior art, the large amount of mold cost and mold time can be saved.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a structure diagram of a liquid crystal display device according to prior art;

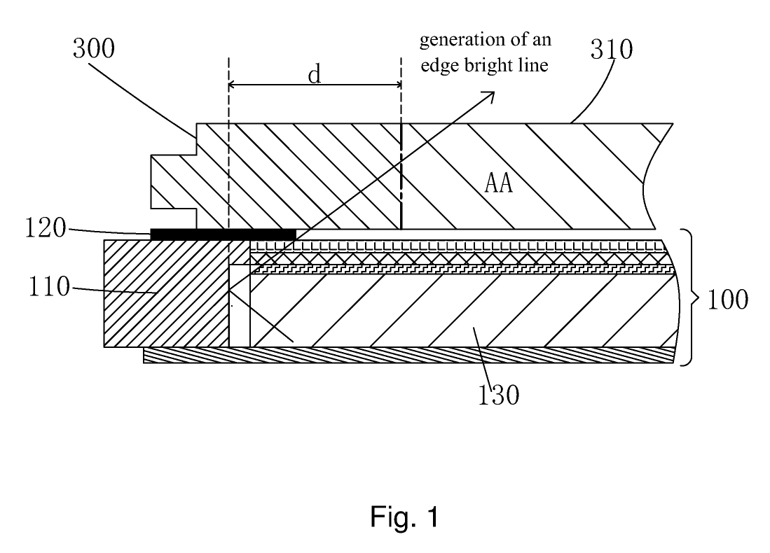

FIG. 2 is a structure diagram of a narrow frame liquid crystal display device according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

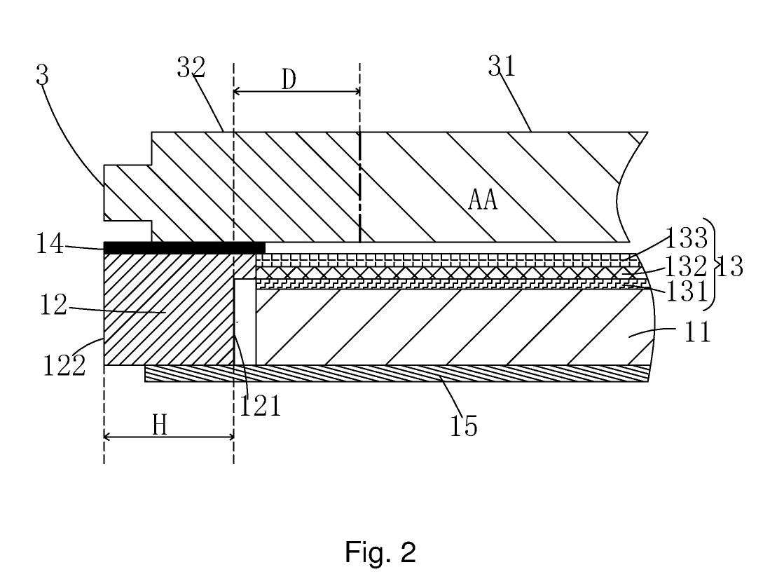

Please refer to FIG. 2. The backlight module provided by the present invention comprises: a light guide plate 11, sealant 12 located at an periphery of the light guide plate 11, and square seal 14, being adhered on the sealant 12 and covering a gap between the light guide plate 11 and the sealant 12, and extending to cover periphery edges of the light guide plate;

the sealant inner wall 121 on the sealant 12 contacting lateral sides of the light guide plate 11 and surrounding the periphery edges of the light guide plate 11 has a graded gray scale.

Specifically, intensities of lights of respective areas on the sealant inner wall 121 which are incident from the light guide plate 11 are not consistent, and the gray scale of the area where the intensity of light on the sealant inner wall 121 which is incident from the light guide plate 11 is stronger, is higher.

Specifically, according to the present technical condition, the sealant only can be narrowed to be 0.4 mm in general. In the present invention, for realizing the narrow frame design, the thickness of the sealant should be narrowed as possible as it could. In this embodiment, the distance H between the sealant outer wall 122 of the sealant 12 opposite to the sealant inner wall 121 and the sealant inner wall 121 is 0.4 mm.

Specifically, the backlight module further comprises an optical film 13 located on the light guide plate 11 and a reflective sheet 15 located below the light guide plate 11; the optical film 13 comprises lower diffusion film 131, a lower prismatic lens 132 and a upper prismatic lens 133 which are sequentially stacked up on the light guide plate.

Specifically, an area of the optical film 13 is equal to an area of the light guide plate 11, and the square seal 14 cover periphery edges of the optical film 13.

In the backlight module of the present invention, the sealant inner wall 121 of the sealant 12 has a surface with a graded gray scale, and thus, as being applied in the liquid crystal display device, it can pertinently increase the gray scale of the sealant inner wall 121 to absorb the light generating an edge bright line to eliminate the edge bright line of the liquid crystal display device, and the square seal 14 is not required to shield the light generating the edge bright line, and then, the distance of the sealant and the edge of the active area of the liquid crystal display can be decreased to achieve the narrow frame design of the liquid crystal display device, and in comparison with the design of increasing the gray scales of the respective areas on the sealant inner wall at the same time to prevent the light leakage, the brightness lose of the backlight module can be reduced and no issue of local uneven brightness exists.

Please refer to FIG. 2. Based on the aforesaid backlight module, the present invention further provides a narrow frame liquid crystal display device, comprising a liquid crystal panel 3 and the aforesaid backlight module, and the backlight module is employed to provide backlight for the liquid crystal panel 3.

The liquid crystal panel 3 comprises an active area 31 and a border area 32 at an outer periphery of the active area 31.

The backlight module comprises: a light guide plate 11, sealant 12 located at an periphery of the light guide plate 11, and square seal 14, being adhered on the sealant 12 and covering a gap between the light guide plate 11 and the sealant 13, and extending to cover periphery edges of the light guide plate;

the sealant 12 comprises a sealant inner wall 121 contacting lateral sides of the light guide plate 11 and surrounding the periphery edges of the light guide plate 11, and the sealant inner wall 121 has a graded gray scale.

Specifically, intensities of lights of respective areas on the sealant inner wall 121 which are incident from the light guide plate 11 are not consistent, and the gray scale of the area where the intensity of light on the sealant inner wall 121 which is incident from the light guide plate 11 is stronger, is higher.

Specifically, according to the present technical condition, the sealant only can be narrowed to be 0.4 mm in general. In the present invention, for realizing the narrow frame design, the thickness of the sealant should be narrowed as possible as it could. In this embodiment, the sealant 12 comprises a sealant outer wall 122 opposite to the sealant inner wall 121, and the distance H between the sealant outer wall 122 and the sealant inner wall 121 is 0.4 mm.

Specifically, the backlight module further comprises an optical film 13 located on the light guide plate 11 and a reflective sheet 15 located below the light guide plate 11; the optical film 13 comprises lower diffusion film 131, a lower prismatic lens 132 and a upper prismatic lens 133 which are sequentially stacked up on the light guide plate.

Specifically, an area of the optical film 13 is equal to an area of the light guide plate 11, and the square seal 14 cover periphery edges of the optical film 13.

Specifically, in the liquid crystal display device of the present invention, the sealant inner wall 121 of the sealant 12 has a surface with a graded gray scale, and then, the edge bright line is eliminated and the brightness lose is reduced. Thus, in this embodiment, the square seal 14 is not required to shield the light generating the edge bright line, and then, the distance D of the sealant inner wall 121 and the edge of the active area 31 can be decreased. In this embodiment, the distance D is 0.6 mm. In comparison with prior art, the side frame of the liquid crystal display device is reduced at least 0.15 mm.

For realizing the aforesaid technical effect, the present invention further provides a formation process of sealant, utilizing 3D printing technology to manufacture the sealant with black material and white material passing through different feed exports according to different ratios to make a gray scale of a wall of the sealant graded. By replacing the traditional mold art with the 3D printing process to manufacture the sealant, the production of the sealant can be easily achieved to solve the issue that the graded color of the sealant wall is hard to be realized with the traditional mold process, and the large amount of mold cost and mold time can be saved.

In conclusion, in the backlight module provided by the present invention, the sealant inner wall of the sealant has a surface with a graded gray scale, and thus, it can pertinently increase the gray scale of the sealant inner wall to absorb the light generating an edge bright line to eliminate the edge bright line of the liquid crystal display device, and then, the distance of the sealant and an edge of the active area of the liquid crystal display can be decreased to achieve the narrow frame design of the liquid crystal display device, and meanwhile to reduce the brightness lose of the backlight module. The narrow frame liquid crystal display device of the present invention utilizes the aforesaid backlight module, and the distance of the sealant and the edge of the active area is smaller to achieve the narrow frame design, and the brightness lose of the backlight module is small. The formation process of sealant according to the present invention utilizes the 3D printing technology to make the gray scale of the sealant inner wall graded. In comparison with the mold prior art, the large amount of mold cost and mold time can be saved.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A backlight module, comprising: a light guide plate, sealant located at an periphery of the light guide plate, and square seal, being adhered on the sealant and covering a gap between the light guide plate and the sealant, and extending to cover periphery edges of the light guide plate;
the sealant comprises a sealant inner wall contacting lateral sides of the light guide plate and surrounding the periphery edges of the light guide plate, and the sealant inner wall has a graded gray scale.

2. The backlight module according to claim 1, wherein intensities of lights of respective areas on the sealant inner wall which are incident from the light guide plate are not consistent.

3. The backlight module according to claim 2, wherein the gray scale of the area where the intensity of light on the sealant inner wall which is incident from the light guide plate is stronger, is higher.

4. The backlight module according to claim 1, wherein the sealant comprises a sealant outer wall opposite to the sealant inner wall, and a distance H between the sealant outer wall and sealant inner wall is below 0.5 mm.

5. The backlight module according to claim 1, further comprising an optical film located on the light guide plate; the optical film comprises lower diffusion film, a lower prismatic lens and an upper prismatic lens which are sequentially stacked up on the light guide plate.

6. The backlight module according to claim 5, wherein an area of the optical film is equal to an area of the light guide plate, and the square seal cover periphery edges of the optical film.

7. The backlight module according to claim 1, further comprising a reflective sheet located below the light guide plate.

8. A narrow frame liquid crystal display device, comprising a liquid crystal panel and the backlight module according to claim 1, and the backlight module is employed to provide backlight for the liquid crystal panel;
the liquid crystal panel comprises an active area and a border area at an outer periphery of the active area.

9. The liquid crystal display device according to claim 8, wherein a distance D between a sealant inner wall and an edge of the active area is 0.6-0.75 mm.

10. A formation process of sealant, utilizing 3D printing technology to manufacture the sealant with black material and white material passing through different feed exports according to different ratios to make a gray scale of a wall of the sealant graded.
